(19) United States
(12) Patent Application Publication
(10) Pub. No.: US 2008/0082924 A1
(43) Pub. Date: Apr. 3, 2008

(54) System for controlling objects in a recursive browser system

(76) Inventor: Joseph Pally, Katy, TX (US)

Correspondence Address: Benjamin Aaron Adler;ADLER & ASSOCIATES, 8011 Candle Lane, Houston, TX, 77071, US

(21) Appl. No.: 11/521,160

(22) Filed: Sep. 14, 2006

(51) Int. Cl. G06F 3/00; G06F 3/048

(52) U.S. Cl. 715/744; 715/700; 715/764

(57) ABSTRACT

Provided herein is a recursive web browser system including a recursive web browser and a computer application executing therein that enables a plurality of functions effective to alter one or more ZCubes or content therein or recursive webpages comprising the same comprising the recursive web browser system. Also provided is a computer-readable storage medium that tangibly stores the executable computer application and instructions enabling operation of the functions. Further provided is a computer-implemented method of altering the ZCubes or content therein or recursive webpages using the recursive web browser system, computer application and functions.

### COMPUTER PROGRAM LISTING APPENDIX

Computer program listings are submitted on compact disc in compliance with 37 C.F.R. §1.96 and are incorporated by reference herein. A total of two (2) compact discs (including duplicates) are submitted herein. The files on each compact disc are listed below:

| Files | Size (KB) | Date Created |
|---|---|---|
| RecursiveBrowserCode.txt | 40 | May 29, 2006 |
| ZBox.txt | 48 | May 29, 2006 |
| Handwriting.txt | 76 | May 29, 2006 |

### BACKGROUND OF THE INVENTION

1. Field of the Invention

The present invention relates generally to the fields of computer technology and web browser systems. More specifically, the present invention provides a system and method to integrate media and to manipulate content within a recursive browser environment.

2. Description of the Related Art

The Internet is arguably the most important innovation of the computer generation. To browse or surf the World Wide Web (the Web) is the fastest and most popular method of obtaining information today. However, current web browsers are primarily read only with little interactive capability. The Internet is to “go and visit” and not part of the experience. A user's experience on the Internet is a temporal series of URLs visited. Furthermore, group collaboration on the Web requires user authentication and is generally site specific.

In addition most users are interested only in snippets of a web site they visit. However, a user must open a word processing, drawing or similar application or access another website to utilize or build on these snippets, if desired, or, for example, to create a document or image de novo. Browsers lack the ability to integrate different types of media according to user preferences. Selective access is missing. A live web is not close to being a reality.

Creating a new browser to address these problems is not an easy solution. It is estimated that a new browser release can cost from $10 million to $100 million. In addition the development and release processes are extremely time consuming. As such, one solution is to use the browser itself to expand browser functionalities.

Thus, there is a significant need in the art for improvements in the area of user-driven experiences. Specifically, the present invention is deficient in systems and methods to display, manipulate and/or create content in a recursive browser environment. The present invention fulfills this long-standing need and desire in the art.

### SUMMARY OF THE INVENTION

The present invention is directed to a recursive web browser system. The recursive browser system comprises a computer having a processor and a recursive web browser configured to recursively display in a browser window thereof one or more recursive webpages having one or more ZCubes containing content therein, a network connection to one or more other computers comprising a network and a computer memory coupled to the processor storing at least one computer application including a plurality of functions effective to manipulate, singly or in combination, said ZCube(s) or the content therein or the recursive webpage(s) containing the same or a combination thereof within the recursive web browser, said computer memory further storing instructions adapted to be executed by the processor to enable operation of the functions thereon. The recursive web browser also comprises a means for retrieving or storing said ZCube(s) or content therein or a combination thereof from or onto said computer or the other computer(s) over the network. The present invention is directed to related recursive computer systems further including, independently, means for storing the computer application onto a computer-readable storage medium and means for launching a user-requested action to create the one or more ZCubes.

The present invention also is directed to a recursive web browser. The recursive web browser comprises a recursive browser window configured to recursively display one or more recursive webpages having one or more ZCubes containing content therein. The recursive web browser also comprises means for accessing a computer memory coupled to a processor and storing the at least one computer application including the plurality of functions described herein such that the computer memory further stores instructions adapted to be executed by the processor to enable operation of the functions on the ZCube(s) or the content therein or the recursive webpage(s) containing the same or a combination thereof, means for launching a user-requested address or action and means for storing the computer application onto a computer-readable storage medium.

The present invention is directed to a related recursive web browser further including a network connection to one or more computers comprising a network and means for retrieving or storing the ZCube(s) or content thereof from or onto the computers over the network and means for storing the computer application onto a computer-readable storage medium. The present invention is directed to another related recursive computer system further comprising a means for launching a user-requested action to create the one or more ZCubes.

The present invention is directed further still to a computer-readable storage medium that tangibly stores a computer application including a plurality of functions effective to manipulate, singly or in combination, one or more ZCubes or content therein or one or more recursive webpages containing the same or a combination thereof displayed in recursive browser window comprising a recursive web browser system such that the computer-readable storage medium further stores instructions adapted to be executed by a processor to enable operation of the functions thereon. The present invention is directed to a related computer-readable storage medium where the functions are operable to, inter alia, organize one or more of the ZCubes within the recursive webpage(s), to arithmetically manipulate the content of the ZCube(s), or to manipulate HTML code or objects comprising the ZCube(s) or content thereof, to enable graphical and scripting functionalities in a recursive webpage, including hand-drawn, handwritten or photographic content, to save the recursive webpage, including the ZCube(s), as read and write files, read-only files or secured files or a suitable combination of these functions.

The present invention is directed further still to a computer-implemented method of altering one or more ZCubes or content therein or a recursive webpage comprising the same displayed within a recursive web browser environment. The method comprises displaying recursively one or more ZCubes within a recursive browser window of one or more computers comprising the recursive computer system described herein and executing the computer application therein where the application enables the plurality of functions described herein which are operable to manipulate, singly or in combination, the HTML code or objects comprising the one or more ZCubes or content therein or a combination thereof thereby altering the ZCube(s) or content therein or the recursive webpage.

The present invention is directed to related methods independently including further steps for retrieving or storing the ZCube(s) or content therein from or onto the computers over the network and means for storing the computer application onto a computer-readable storage medium. The present invention is directed to another related method comprising a further method step of launching a user-requested action to create the one or more ZCubes.

Other and further aspects, features and advantages of the present invention will be apparent from the following description of the presently preferred embodiments of the invention. These embodiments are given for the purpose of disclosure.

### DETAILED DESCRIPTION OF THE INVENTION

In one embodiment of the present invention there is provided a recursive web browser system, comprising a computer having a processor and a recursive web browser configured to recursively display in a browser window thereof one or more recursive webpages having one or more ZCubes containing content therein; a network connection to one or more other computers comprising a network; a computer memory coupled to the processor storing at least one computer application including a plurality of functions effective to manipulate, singly or in combination, the ZCube(s) or the content therein or a recursive webpage containing the same or a combination thereof within the recursive web browser, where the computer memory further stores instructions adapted to be executed by the processor to enable operation of the functions thereon; and means for retrieving or storing said ZCube(s) or content therein or a combination thereof from or onto said computer or the other computer(s) over the network.

Further to this embodiment the recursive web browser system may comprise a means for storing the computer application onto a computer-readable storage medium. Also the recursive web browser system may further comprise a means for launching a user-requested action to create the one or more ZCubes. The user-requested action and the computer application are described supra. In all these embodiments, one or more of the other computers may include a recursive web browser.

In one aspect of these embodiments, the function(s) may operate to organize one or more of the ZCubes within the ZPage. Exemplary function(s) operate to select a ZCube(s) therewithin, to align ZCubes, to tile the ZCube(s), to array the ZCubes as a cascade, to layer the ZCubes, to delete a ZCube(s) or a part of the content therefrom or a combination thereof. Particularly, the layering function operates to adjust layers of the ZCube(s) one on top of the other or to merge two or more layers thereby enabling viewing of all the contents contained therein. Further to layering ZCubes, a function(s) may operate to create a hierarchy of windows within one or more ZCubes.

Further to selecting one or more ZCubes, the function(s) may operate to group the selected ZCubes and to apply one or more other functions to the group. One example of a function which may be further applied to the selected group is resizing. Also, further to selecting the function may operate to display consecutively each ZCube comprising a selected set of ZCubes within another Zcube using timelines. In addition, further to selecting the function may operate to rubberband ZCubes or at least part of the content therein into a selected set upon which other functions operate. Furthermore, in this aspect the function(s) may operate to add one or more push pins or pointers to one or more ZCubes.

In another aspect of these embodiments, the functions may operate to arithmetically manipulate the content of the ZCube(s). In particular examples of arithmetical manipulation, the functions may operate to add content from a ZCube(s) to another ZCube, to subtract content of two or more ZCubes from a first ZCube, to multiply the content of a ZCube a user-selected number of times, or to divide content of a ZCube into one or more new ZCubes. In yet another aspect of these embodiments the functions may operate to save the recursive webpage, including the ZCube(s), as read and write files, read-only files or secured files.

In yet another aspect the function(s) may operate to manipulate HTML code or objects comprising the ZCube(s) or content therein or the recursive webpages containing the same. In one example the functions may operate to enable drag and drop functionalities. Particularly, the functions operate to drag and drop color, formats, transitions, or filters into an HTML webpage or a combination thereof. In another example, the functions may operate to extract one or more links from a ZCube(s). Particularly, the functions operate to explode link(s), extract media, explore the link(s) using an associated URL tree or execute the link(s) as a script or a combination thereof.

In yet another aspect the functions may operate to enable graphical and scripting functionalities in the recursive webpage. Particularly, the functions operate to create handdrawn or handwritten content in the recursive webpage using VML or SVG. In addition, further to creating handdrawings or handwritings, the function(s) may operate on the hand-drawn or handwritten content to apply selected color(s), to fill, to shadow, to make 3-dimensional, to rotate in x-y-z directions, to add text or handwriting, to animate using timelines, or a combination thereof. Further still, the functions may operate to memorize a scheme of selected colors or drawing functions and retrievably store the same.

In yet another aspect the ZCube(s) content comprises one or both of a graphical object or a photographic object. In this aspect the functions operate on the ZCube(s) content to drag and drop one or more of color(s), format(s), font-size(s), font-type(s), font-color(s), font-weight(s), text(s), transition(s), or special effect(s) thereon or to size, position, rotate in x-y-z directions, zoom or unzoom, layer, script, animate using a timeline, or make 3-dimensional, or a combination thereof. Particularly, the ZCube(s) content may be a photographic object, where further functions are operable to create hand-drawn content thereon, to create handwritten content thereon, to add push pin(s) thereto, or a combination thereof.

In another embodiment of the present invention there is provided a recursive browser window configured to recursively display one or more recursive webpages having one or more ZCubes containing content therein; means for accessing a computer memory coupled to a processor and storing the at least one computer application including the plurality of functions described supra, where the computer memory further stores instructions adapted to be executed by the processor to enable operation of the functions on the ZCube(s) or the content therein or the recursive webpage(s) containing the same or a combination thereof; means for launching a user-requested address or action; and means for storing the computer application onto a computer-readable storage medium.

Further to this embodiment the recursive web browser may comprise a network connection to one or more computers comprising a network and a means for retrieving or storing the zCube(s) or content thereof from or onto the other computer(s) over the network. The step of launching a user-requested action, the example of a user-requested action and the computer application are as described supra.

In yet another embodiment of the present invention there is provided a computer-readable storage medium that tangibly stores a computer application including a plurality of functions effective to manipulate, singly or in combination, one or more ZCubes or content therein or one or more recursive webpages containing the same or a combination thereof displayed in recursive browser window comprising a recursive web browser system, where the computer-readable storage medium further stores instructions adapted to be executed by a processor to enable operation of the functions thereon. The operable functions are as described supra.

In yet another embodiment of the present invention there is provided a computer-implemented method for altering one or more ZCubes or content therein or a recursive webpage comprising the same displayed within a recursive web browser environment, comprising displaying recursively one or more ZCubes or one or more recursive webpages comprising the same within a recursive browser window of one or more computers comprising the recursive web browser system described supra; and executing the computer application therein, where the computer application enables the plurality of functions described supra, such that the functions are operable to manipulate, singly or in combination, the HTML code or objects comprising the one or more ZCubes or content therein or webpage comprising the same or a combination thereof thereby altering the ZCubes or content therein or recursive webpage. The operable functions are described supra.

Further to this embodiment the method may comprise retrieving or storing the ZCube(s) or content therein from or onto said computers over the network. Also further to this embodiment the method may comprise storing the computer application onto a computer-readable storage medium. In addition the method may further comprise launching a user-requested action to create the one or more ZCubes. As examples, the user-requested action may be launched from an action bar within the recursive browser window or from an address bar located in a browser platform associated with the recursive web browser which triggers the action bar.

As used herein, the term “a” or “an” may mean one or more. As used herein in the claim(s), when used in conjunction with the word “comprising”, the words “a” or “an” may mean one or more than one. As used herein “another” or “other” may mean at least a second or more of the same or different claim element of components thereof. As used herein, the term(s) “recursive browser” or “zBrowser” refers to a browser that uses existing browsers to enhance their functionality and to provide 3 dimensional multipart full browser functionality to improve browser experience. As used herein, the term “Action Bar” refers to a targeting bar, which may be the conventional URL bar, that can also be triggered from html or :href calls invoking, e.g., one or more web actions, web sites, web services, or action triggers. As used herein, the term(s) “ZBox” refers to a part of a ZPage that contains an html object(s), for example, but not limited to, images, scripts, shockwave, and a recursive browser. ZBoxes are copyable and individually and selectively formattable with drag-drop of style text. As used herein, the term(s) “ZPage ” or “ZBrowser page” or “recursive webpage” refers to a container of one or more ZBoxes/ZCubes that encompasses logic to display, edit, move, browse, rotate, hide, animate, and run scripts within the recursive browser. Parts of a ZPage are copyable and individually and selectively formatable with drag-drop of style text. A ZPage can be controlled by Zebra, i.e. ZBox algebra, and is composed from data (that could be stored separately) with logic coming from the ZCube server files. ZPage can receive and conduct Jumping-Jax (dynamically obtained server based javascripts), effecting dynamic page maintenance. A ZPage also may be called zSpace or zWorld when comprising multiple layers. As used herein, the term(s) “ZEditor” refers to a ZPage or recursive webpage that is a page, either local or on the web, primarily composed of HTML, which allows parts of the page, e.g., ZBoxes or ZCubes comprising one or more of the same, which may be shared by groups of users, groups of ZBoxes, window layer, or background-layer, to be selected, edited, or dragged-and-dropped, to effect creation of new objects upon demand, by dragging-dropping, double-clicking, or pasting, based on instructions of the incoming HTML or script of diverse media, to receive events from and into individual ZBoxes and routing them, to contain zBrowser(s), VML, SVG or other hand-drawings/handwritings with pointers to remote or local ZBoxes or with individually addressable ZBoxes or controls. As used herein, the term(s) “ZCube” refers to a collection of one or more ZBoxes contained within a ZPage or recursive webpage. Unless specifically indicated otherwise the terms “ZBox” and “ZCube” are interchangeable. A ZCube may be made from templates that are stored in a gallery. The ZCube may be moved/rotated over a user-defined path and then may be animated. A ZCube can be made “read only”. A ZCube may have push pins added to it or comprise other pointers. A ZCube may be in multiple layers. As used herein, the term(s) “ZCube world” refers to one or more sets of ZCube collections displayed under one context to the user. A ZCube world may contain ZPages. As used herein, the term “ZCycle bin” refers to a location within the recursive web browser where deleted ZCubes are stored.

Provided herein is a computer-based recursive web browser system, methods and applications effective to control, manipulate or modify content within a recursive browser environment. The recursive browser comprises an Action Bar within the ZBrowser window or ZPage or recursive webpage as an entry point for any retrievable URL or executable action trigger within the zBrowser environment. The ZBrowser is enabled to recursively display one or more zPages within the browser window whether containing content or blank. Furthermore, using the Action Bar, a user may interact or create within a ZPage or recursive webpage or may open one or more ZCubes within ZPage(s) or recursive webpages and retrieve or create content therein.

The recursive browser system and computer-implemented methods described herein may utilize a ZBox Algebra or Zebra application. Zebra or the source code thereof may be stored in and retrieved from computer memory or a computer program product having a memory in a recursive browser environment or a computer-readable storage medium, as are well-known and standard in the art. Zebra is supported by ZCubes and is effective to manipulate html code or objects, as comprising ZBox(es) or content therein, within the browser environment. ZCubes is a thin web-browser based environment without add-ins or plug-ins. A ZCubes environment allows a user to integrate a wide variety of media, to manage content and to save and to store content. Generally, within a recursive browser window, ZCubes enables infinite page size in the x-, y- and z-directions, linked ZBoxes and addressable ZBoxes. Both ZBox and ZCubes can be script driven or implemented with drag/drop processes. ZCube(s) may include layers and hierarchical windows thereby forming a Zworld with multiple layers.

The ZCubes environment has the capabilities of a fully functional browser, a web content editor, photo management, multi-media integration, handwriting, JS scripting, QJax for client driven calls, and Jumping Jax for server driven calls. The ZCubes provide support for containing any activeX enabled application, for example, but not limited to, PDF, Excel or Visio. As such, ZCubes enables Zebra to perform arithmetical operations, i.e., adding, subtracting, multiplying and dividing, along with actions or functions such as, but not limited to, merging, swapping, deleting, and copying.

Each ZCube independently may be sized, layered, positioned, formatted, zoomed or unzoomed, scripted, copied, swapped, deleted and extracted. A ZCube may comprise any arbitrary HTML, applications, recursively included ZCubes or browser components. Also, a ZCube can wrap any arbitrary HTML. A ZCube also may represent actions, triggers or locators performable on the Web.

As provided herein Zebra is effective to manipulate, control or modify HTML or HTML objects of a ZCube or of a ZBox or one or more ZBoxes within a ZCube. Zebra comprises functions effective for manipulating the HTML of the ZCube itself or the HTML of the ZCube contents. As described herein, the term “SomeBox” generically refers to the name of the particular ZCube. For example, and without being limiting, Z(SomeBox) retrieves the innerHTML or inside contents of the ZBox and ZO(SomeBox) retrieves the outer HTML or full HTML of a ZBox or ZCube. The objects or elements contained within a ZBox/ZCube also may be manipulated. For example, ZObject(SomeBox) retrieves the Object Reference to a ZBox element. Also, ZContentObject(SomeBox) retrieves the Object Reference to the inside content of a ZBox element. In addition ZText(SomeBox) retrieves the Inside Text Only content from inside of a ZBox element. ZSafeShow(SomeText) makes the HTML wrapper to a ZBox content to be safely shown inside a document.

Furthermore, the present invention provides a publishing feature or function, i.e., ZPublish. Generally, the ZPage, together with all the zCubes and their contents, created by a user can be saved on to the ZCubes server, in public mode or read and write files, private mode or read-only files or protected mode or. Classifying a ZPage as public means anyone can create the page, any one or more users can read the page given the URL/UIN and any one or more users can edit the page given the URL/UIN. Classifying a ZPage as private means any one or more users with a ZACID can create the page, any one or more users can read the page given the URL/UIN and any one or more users with authentication can edit the page. Classifying a ZPage as protected means any one or more users with a ZACID can create the page and any one or more users with authentication can read and edit the page. A ZACID, e.g. hash(username+password), is embedded in a*._zac file as an encrypted version of itself and enables ZCubes and/or Zpages to be stored and retrieved as secured files. ZAC files may be opened in a recursive browser window to automatically authenticate and setup the settings for a user.

One or more ZBoxes/ZCubes per se may be manipulated or modified. For example, a ZCube may be created or destroyed. The function ZC(SomeContent) creates a new ZBox or ZCube. The function ZK(SomeBox) retrieves the inner HTML or inside contents of a ZBox and destroys the original box or, alternatively, ZKO(SomeBox) retrieves the outerHTML or full HTML of a ZBox and destroys the original box. Both functions are useful when a new ZBox(es) is created recursively. EditHTML(BoxID) dynamically edits the HTML inside a ZBox using another ZBox.

Also, Zebra is effective to alter or change the style or look of a Zbox or ZCube, such as to drag and drop, inter alia, color, formats, font settings, including, but not limited to, font-size, font-type, font-color, or font-weight, transitions, or filters into an HTML webpage. For example, TryToMergeStyle(SomeBoxlndex) merges a dragged and dropped style string into a box to alter its properties. Particularly, ZColor(SomeBox, SomeColor) sets colors of a ZBox. In addition ZFit(SomeBoxID) Fit a ZBox with certain attributes. ZBorderHide(SomeBoxId) hides the borders of a ZBox while ZBorderShow(SomeBoxId) shows the borders of a ZBox. In addition HideBox(SomeBoxIdentifier) hides a ZBox while UnhideBox(SomeBoxIdentifier) unhides it. ClearAllBoxes( ) clears content from all ZBoxes while ZClear(SomeBox) clears content from a single ZBox. ZRotate(SomeBox) rotates a ZBox within a ZPage.

Zebra also enables the display of ZBoxes or content on a ZPage or recursive webpage or within a ZCube or ZCubes world to be altered. Selected ZBoxes may be tiled using Tile( ) or cascaded using Cascade( ). The function InLay takes the content from a ZBox and lays it on the background layer. In addition ZPrint(SomeSelection) prints only selected ZBoxes in specific patterns, as requested by the user.

In addition, Zebra enables the status of ZBox(es)/ZCubes to be tracked or queried or the ZBox/ZCube to be identified. For example, ZExist(SomeBoxId) checks to see if a ZBox exists while IsZBox(SomeBox) queries if an object is a ZBox. In other examples ZId(SomeID) retrieves the ID of a ZBox. ZFind(SomeBox) finds a specific ZBox and shows it raised. ZHeader(SomeBox) retrieves the header of a ZBox. GetZBoxList( ) retrieves a list of ZBoxes. Furthermore, ReadOnly(SomeObject) checks if a ZBox is read only and MakeReadOnly(SomeBox, SomeFlag) makes a ZBox read only

As such, Zebra enables ZBoxes/ZCubes to be listed and/or enumerated or otherwise identified. For example, ZList( ) makes a list of ZBoxes whereas MakeZList(SomeType) makes a list of names of ZBoxes of a certain type. ZVisibleList( ) makes a list of visible ZBoxes. In addition, ZCount( ) retrieves a count of ZBoxes whereas ZvisibleCount retrieves a count of visible ZBoxes. Furthermore, GetBoxlndex(SomeSpaceName) retrieves the numeric index of a ZBox, which can be used to reference the name of a ZBox's elements including, inter alia, space, content, and bar. A ZBox/ZCube also may be renamed using ZRename(SomeBox1, SomeBox2).

Furthermore, Zebra enables event handling in a ZBox/ZCube. ZSetEvent(SomeBox, SomeEvent, SomeScript) sets an Event handler for a ZBox. When the event occurs, the ZBox executes a script associated with the event. ZSet(SomeBox, SomeKey, SomeValue) sets a variable specific to a ZBox. This can be used for saving the state of a ZBox. Then ZGet(SomeBox, SomeKey) gets a variable specific to a ZBox that was set using ZSet. This can be used for retrieving the state of a ZBox. ZGetEvent(SomeBox, SomeEvent) retrieves information about an Event that was set using ZSetEvent.

Script within a ZBox(es)/ZCubes may be manipulated. IsPossibleJS(SomeString,SomeRegularExpression) detects if a script is a valid script. MakeCodeExecute(Something, SomeFunctionName, SomeArguments) executes the script contained within a ZBox with parameters supplied separately or coded inside. Similarly, ApplyJS(SomeBoxCode, SomeBoxValue) runs a script given to a ZBox. Also Zebra enables the media resource links from an arbitrary text contained in a ZBox to be retrieved using ExpandMedia(BoxIDControl) or a page title of a link in a ZBox to be retrieved through QJax calls using GetPageTitle(RequestedPageContent)/SetLinkTitle(RequestedPageContent, SomeControlText, SomeLinkBar).

In addition, events themselves may be manipulated. ZRaiseEvent(SomeBox, SomeMessageType, SomeEventArgs) raises an event for a ZBox with the type and arguments. ZDistributeEvents(SomeMessageType, SomeBox, SomeEventArgs) pumps the events to the ZBoxes. ZPointerEvents(SomeBox) is useful to send a pointer affecting an event to a ZBox. Also, ZRegisterEventListener(SomeMessageType, SomeSourceBox, SomeListenerBox) registers event listeners for a aBox to another ZBox for a specific event type.

Zebra enables the use of pointers in general. ZPointer(BoxId,PointedBoxId,RemotePointerTo) sets a ZBox to point to another ZBox or to a ZBox/div/span/rectangular area inside a Zcube world or Zpage, or any HTML page, and even a remote ZCube World or ZPage or any HTML page. RemoteZPointer(ZBoxContent,RemotePointerTo)/ZsetPointer(BoxId,Pointed BoxId) sets a ZPointer to a ZBox or part of a remote zWorld or ZPage. In addition ZDeletePointer(BoxId,PointedBoxId) deletes a zPointer.

ZCubes and/or the content or objects therein may be selected individually and, optionally, subsequently grouped. For example, a rubberbanding function may be applied to zCubes or to at least part of the content or objects therein to form a set comprising the specific selections. As provided herein rubberbanding is the process of selecting a set of ZCubes or content therein or other objects displayed in a recursive webpage or Zpage by clicking on the left top of the page and dragging the mouse to the right bottom. A dotted-line rectangle outlines the area encompassing the selections during the rubberbanding process. The ZCubes, content or objects within this area is then called a selection for further processing. Also, selected ZCubes or a group of ZCubes may be displayed using a slide show feature, i.e., ZSlideShow. More specifically, a set of selected ZCubes may be displayed actively and consecutively in a single zCube. A specified timeline may regulate the time between display of each zCube.

Thus, Zebra enables one or more functions to be applied to one or more ZCubes or to the content thereof or to a selected set or group comprising the same. For example, both ApplyFunctionToBoxes(SomeSelectedZBoxes, SomeFunction, InsideFlag, IsGiveResult) and ApplyFunctionToSelection(SomeFunction), which are functionally equivalent, apply a function or groups of functions to the current single or multiple selection of ZCubes. Alternatively, ApplyFunctionToSelectionOnContent(SomeFunction) applies a function or groups of functions to the current single or multiple selection of ZCube content.

Particularly, Zebra or ZBox-Algebra may use arithmetical operators, e.g., addition, subtraction, multiplication, or division, to manipulate content or objects of one or more ZBoxes. The function Add(z1, z2) may add the contents of two or more ZBoxes while the function Subtract(z1, z2) may subtract contents of two or more ZBoxes from the first ZBox, e.g., subtract links. Also, the content of a given ZBox may be multiplied by adding the content an x number of times to a ZBox using Multiply(z1, x). Alternatively, a ZBox having more than one link may be divided. The function Divide(z1) takes each link from the content and launches a new ZBox for each link containing the URL expansion content.

As such ZBoxes may be expanded or contracted. For example, the function Expand(z1) takes each link from the content and expands each link inside the given ZBox to contain all of them. Alternatively, the function Contract(z1) recreates a list of URLs that were the original expanded content by the Expand operation.

Zebra enables manipulation or modification of the contents of the ZBox/ZCube. ZContentSet(ZBoxId, SomeContent) sets the content of a ZBox. Content may be provided to a ZBox in several ways. For example the content of a single ZBox may be loaded from a server using LoadBlockFromServer(BlockContents, SomeFunctionName, ZBoxId)/DownLoadBlockFromServer. Alternatively, CreateNewZBoxWithPaste( ) takes a copied content from another ZPage/xWorld into a ZCube with all the necessary formatting, etc. In other examples ZCopy(SomeBox1, SomeBox2) copies the content of one ZBox to another ZBox and ZSwap(SomeBox1, SomeBox2) swaps the content of one ZBox with another ZBox. In addition, ZShow(SomeBox, SomeText) shows a content given SomeText into a box. ZAppend(SomeBox, SomeText, AtBottom) appends a given content SomeText to the contents of a box. ZGetSelection( ) gets the content of all the ZBoxes in the selection to a single element to make them into one box. FindActiveZBox( ) finds the active selection or active box.

Content in a ZBox may be edited. CallZBoxEditor(ServerNameZBoxId) call the full-fledged editor to edit content of the ZBox(es). Also, the content of a ZBox may be given to the drag mechanism using GiveToDrag( ). Similarly, a dragged and dropped content may be merged into a box considering the media type, etc. using MergeIntoBox(SomeElement, SomeText). For example, and without being limiting, if the media type is a shockwave file, it is given to the appropriate HTML wrapper. Alternatively, content, as a zNote, may be set as a shareable element by saving it on a server and pulling it into the client.

Zebra enables the modification or manipulation of ZCubes or zCubesWorld within a recursive web browser. For example, ApplyAttribute(SomeObjectId, SomeAttribute, SomeValue) applies an arbitrary attribute to an object, such as a ZCube. ShowCubeHeader(SomeCube) and ShowCubeFooter(SomeCube) show or hide the header or footer of a ZCube. ZoomIn/ZoomOut allows a user to zoom in and out of the ZCubes Worlds. In another example AddPaste(SomeNewWindowID)//adds a copied content from another ZPage/ZWorld into a ZCube with all necessary formatting, etc. In still other examples, ChangeCSS(CssFileName) changes the style-sheet of a zWorld dynamically. SplitScreen(IsLeft) splits the screen in different ways to display ZCube Worlds and a paired browser instance. ZSpacePrint( ) prints the ZWorld.

Zebra also enables ZMail which is similar to a ZPage with all the attachments open. Messages and attachments each open in separate ZBoxes. Also, additional responses open in separate ZBoxes. Zmail may include authentication mechanisms. In addition, a handwriting function, which may be a wavy handwriting function, may be included in the email. Furthermore, zMail may encompass email with a chat function inside. Zmail may also combine with access restrictions.

Also provided is a photo management tool, i.e., ZStudio. ZCube(s) and the photographic content may be manipulated or changed or altered as described variously supra. For example, drag and drop functions may alter color, formats, font settings, including font-size, font-type, font-color, or font-weight or to apply transitions or special effects to the ZCube(s) and/or photograph(s). Also, a ZCube containing photograph(s) may have push pins added thereto. Generally, each photograph independently may be sized, layered, positioned, formatted, zoomed or un-zoomed, or scripted, etc. The photograph(s) may be moved or rotated and, optionally, further may be animated. Also, hand-drawn or handwritten content may be created on the photograph(s). In addition, photo album features, for example, but not limited to, photo corners may be added to a photograph.

Also provided is ZPaint or zDraw which, as an extension of Zebra, is used to color or paint graphical objects on a webpage. The ZScript documentation comprises a plurality of functions which, inter alia, paint, color, graphically draw, add to, move, delete, resize graphical objects in one or more ZBoxes or ZCubes, animate the objects using timelines, and rotate the ZCubes in 3-dimensions. In particular nonlimiting examples, ZCube(s) or the graphical content or graphical object(s) therein may be 3-dimensional and may be individually rotated in x-y-z directions. Text, including handwritten text, may be added to hand-drawn or graphical objects, such as to identify the object, e.g., heart, star, etc.

Also, ZPaint/Zdraw provides different color themes or specific themes may be chosen. In addition, ZDraw provides different drawing functions, such as, but not limited to, filling, shadowing, animating or making one or more graphical objects 3-dimensional Furthermore, specific color schemes settings and draw settings may be memorized and subsequently retrieved.

The function ZBeginPaint( ) prepares for painting. It is the very first function to be called and can only be called once. ZBeginPaint( ) has no parameters. The function ZSetCanvas( ) sets the active canvas to paint on. This function also is only expected to be called once after ZBeginPaint. The parameter(s) is CanvasId—Specifies HTML element ID of the canvas. A nonlimiting example of script is ZSetCanvas(MyCanvas);

Another function of Zpaint is ZSetActiveStroke( ) which sets the active stroke of device context. Without being limiting one parameter is StrokeColor which sets the stroke color by color names or RGB values as a string with the Default set as ‘black’. Another parameter is StrokeWeight which sets the stroke weight in pixels where the Default is ‘1px’. Yet another parameter is StrokeStyle which specifies the dot and dash pattern for a stroke. Values for StrokeStyle include, but are not limited to, ‘Solid’ (default), ‘ShortDash’, ‘ShortDot’, ‘ShortDashDot’, ‘ShortDashDotDot’, ‘Dot’, ‘Dash’, ‘LongDash’, ‘DashDot’, ‘LongDashDot’, and ‘LongDashDotDot’. Nonlimiting examples are ZSetActiveStroke(‘#55FFEE’), ZSetActiveStroke(‘red’, 10) and ZSetActiveStroke(‘yellow’, ‘5px’, ‘ShortDash’);

The function ZSetActiveFill( )sets the active fill of device context. Without being limiting one parameter is FillColor which sets the fill color by color names or RGB values as a string. If this parameter is not specified, then there is no fill. Another parameter is FillColor2 which sets the second fill color by color names or RGB values as a string. Yet another parameter is GradientAngle which sets the gradient angle in degrees for a gradient of FillColor and FillColor2. The default value is 0 degrees, which is a horizontal vector from left to right. Positive angles rotate the gradient in a counter-clockwise direction. Nonlimiting examples are ZSetActiveFill( ) ZSetActiveFill(‘blue’), ZSetActiveFill(‘red’, ‘yellow’), and ZSetActiveFill(‘red’, ‘yellow’, 150).

The function ZSetActiveExtrusion( ) sets the active extrusion of device context. One parameter may be On which determines whether an extrusion will be displayed. Another parameter may be Type which defines the way that the shape is extruded. Values include a ‘parallel’ type of extrusion that is rendered so that the center of projection is infinitely far away; that is, the extrusion lines do not converge (unlike perspective projections), a ‘perspective’ type of extrusion that is rendered to a center of projection, which is the same as the vanishing point for unrotated objects, BackDepth which defines the amount of backward extrusion in number of pixcels, and Color which defines the color of the extrusion faces by color names or RGB values as a string where Default is ‘black’. Nonlimiting examples are ZSetActiveExtrusion(false), ZSetActiveExtrusion(‘TRue’, “parallel”, ‘20’) and ZSetActiveExtrusion(‘TRue’, “parallel”, 10, “yellow”).

The function ZSaveCurrentGDC( ) saves the current graphic device context into a variable for recovering later by ZSetGDC. The graphic device context includes stroke, fill, extrusion, font, light, rotations, and other properties. There are no parameters. The Return Value is CurrentGDC which contains the current graphic device context.

The function ZSetGDC( ) retrieves a variable of graphic device context for canvas and restore it. A parameter may be SomeGDC which specifies a previously saved graphic device context by ZSaveCurrentGDC.

The function ZPoint( ) generates a point to be later used in the graphic drawing functions. A parameter may be X, Y which specfies a point. The Return Value is a point to be used in shape drawing functions. Nonlimiting examples are ZEllipse(ZPoint(100, 100), ZPoint(200, 200)).

The function ZPoints( ) generates a few points to be later used in the graphic drawing functions. The parameters are X1, Y1, X2, Y2, . . . , Xn, Yn which specify some points. The Return Values are a few points to be used in shape drawing functions. A nonlimiting example is ZEllipse(ZPoints(100, 100, 200, 200)).

The function ZMoveTo( ) moves the current position to (X,Y). Parameters may be X, Y or Zpoint. Nonlimiting examples are ZMoveTo(100, 150) and ZMoveTo(ZPoint(100, 150)).

The function ZEllipse( ) draws an ellipse. The current position is neither used nor updated by ZEllipse. Parameters may be X1, Y1, X2, Y2 or ZPoint or ZPoints which specify the left, top, right and bottom of the box around the ellipse. The Return Value is the ID of the shape that has been drawn. Nonlimiting examples are ZEllipse(100, 100, 200, 200); ZEllipse(ZPoint(100, 100), ZPoint(200, 200)), ZEllipse(ZPoints(100, 100, 200, 200)).

The function ZEllipseTo( ) draws an ellipse from the current position to the specified point. The current position is then moved to the specified point. The parameters may be X, Y or ZPoint which specify the right and bottom of the box around the ellipse. The current position is the left top corner. The Return Value is the ID of the shape has been drawn. Nonlimiting examples are ZEllipseTo(200, 200) and ZEllipseTo(ZPoint(200, 200)).

The function ZCircle( ) draws a circle. The current position is neither used nor updated by ZCircle. One parameter may be X, Y or ZPoint which specify the center of the circle to be drawn. Another parameter may be Radius which specifies the radius of the circle to be drawn. The Return Value is the ID of the shape has been drawn. Nonlimiting examples are ZCircle(100, 100, 50) and ZCircle(ZPoint(100, 100), 50) where 50 is the radius.

The function ZRectangle( ) draws a rectangle. The current position is neither used nor updated by ZRectangle. The parameters may be X1, Y1, X2, Y2 or ZPoint or ZPoints which specify the left, top, right and bottom of the box around the rectangle. The Return Value is the ID of the shape has been drawn. Nonlimiting examples are var r=ZRectangle(100, 100, 200, 200), ZRectangle(ZPoint(100, 100), ZPoint(200, 200)), and ZRectangle(ZPoints(100, 100, 200, 200)).

The function ZRectangleTo( ) draws a rectangle from the current position to the specified point. The current position is then moved to the specified point. Parameters may be X, Y or ZPoint which specify the right and bottom of the box around the rectangle. The current position is the left top corner. The Return Value is the ID of the shape has been drawn. Nonlimiting examples are ZRectangleTo(200, 200) and ZRectangleTo(ZPoint(200, 200)).

The function ZRoundRectangle( ) draws a rounded rectangle. The current position is neither used nor updated by ZRectangle. The rounded corners of the rounded rectangle is defined as a percentage of half the smaller dimension of the length and width of a rectangle. 0% would have square corners, and 100% would form circular corners. A square with an ArcSize value of 1.0 would be a circle. The default value is 0.2 (20%). The parameters may be X1, Y1, X2, Y2 or ZPoint or ZPoints which specify the left, top, right and bottom of the box around the rounded rectangle. ArcSize is defined as a percentage of half the smaller dimension of the length and width of a rectangle. 0% would have square corners, and 100% would form circular corners. A square with an ArcSize value of 1.0 would be a circle. The default value is 0.2 (20%). The Return Value is the ID of the shape has been drawn. Nonlimiting examples are ZRoundRectangle(150, 230, 300, 400), ZRoundRectangle(150, 230, 300, 400, 0.5), ZRoundRectangle(ZPoint(100, 100), ZPoint(200, 200), 0.1), and ZRoundRectangle(ZPoints(100, 100, 200, 200), 0.3).

The function ZRoundRectangleTo( ) draws a rounded rectangle from the current position to the specified point. The current position is then moved to the specified point. The rounded corners of the rounded rectangle is defined as a percentage of half the smaller dimension of the length and width of a rectangle. 0% would have square corners, and 100% would form circular corners. A square with an ArcSize value of 1.0 would be a circle. The default value is 0.2 (20%). Parametera may be X, Y or ZPoint which specify the right and bottom of the box around the rounded rectangle. The current position is the left top corner. ArcSize is as defined supra. The Return Value is the ID of the shape has been drawn. Nonlimiting examples are ZRoundRectangleTo(300, 400), ZRoundRectangleTo(300, 400, 0.5), and ZRoundRectangleTo(ZPoint(200, 200), 0.1).

The function ZArc( ) draws an arc with startangle and endAngle in degrees. The current position is neither used nor updated by ZArc. The default value of StartAngle and EndAngle is 0 degrees and 90 degrees. Parameters may be X1, Y1, X2, Y2 or ZPoint or ZPoints which specify the left, top, right and bottom of the box around the arc. StartAngle defines the start of an arc. The start of an arc is defined by an angle measured from straight up (12 o'clock) clockwise. The default value is 0 degrees. EndAngle defines the end of an arc. The end of an arc is defined by an angle measured from straight up (12 o'clock) clockwise. The default value is 90 degrees. The Return Value is the ID of the shape has been drawn. Nonlimiting examples are ZArc(100, 100, 200, 200), ZArc(ZPoint(100, 100), ZPoint(200, 200), 20, 120) and ZArc(ZPoints(100, 100, 200, 200), 30).

The function ZArcTo( ) draws an arc with startAngle and endAngle in degrees from the current position to the specified point. The current position is then moved to the specified point. The default value of StartAngle and EndAngle is 0 degrees and 90 degrees. StartAngle and endAngle are as defined supra. The parameters may be X, Y or ZPoint which specify the right and bottom of the box around the arc. The current position is the left top corner. The Return Value is the ID of the shape has been drawn. Nonlimiting examples are ZArcTo(200, 200), ZArcTo(ZPoint(200, 200), 20, 120) and ZArcTo(ZPoint(200, 200), 30).

The function ZImage( ) draws an image specified by ImageSource. The current position is neither used nor updated by ZImage. Parameters may be X1, Y1, X2, Y2 or ZPoint or ZPoints which specify the left, top, right and bottom of the box around the image. ImageSource specifies a path string pointing to the source of the image stored. The Return Value is the ID of the shape has been drawn. Nonlimiting examples are ZImage(300,300, 500, 500, “ . . . /images/myimagejpg”), and ZImage(ZPoints(300,300, 500, 500), “ . . . /images/myimage.jpg”).

The function ZImageTo( ) draws an image specified by ImageSource from the current position to the specified point. The current position is then moved to the specified point. The parameters may be X, Y or ZPoint which specify the right and bottom of the box around the image. The current position is the left top corner. ImageSource is as described supra. The Return Value is the ID of the shape has been drawn. Nonlimiting examples are ZImageTo(500, 500, “ . . . /images/myimagejpg”) and ZImageTo(ZPoint(500, 500), “ . . . /images/myimage.jpg”).

The function ZLine( ) draws a line. The current position is neither used nor updated by ZLine. Parameters may be XBegin, YBegin, XEnd, YEnd or ZPoint or ZPoints which specify the beginpoint and the endpoint of the line. The Return Value is the ID of the shape has been drawn. Nonlimiting examples are ZLine(ZPoint(300, 400), ZPoint(100, 200)), ZLine(ZPoints(300, 400, 100, 200)) and ZLine(300, 400, 100, 200).

The function ZLineTo( )draws a line from the current position to the specified point and sets the current position to the specified endpoint. Parameters may be X, Y or ZPoint—Specify the endpoint of the line. The Return Value is the ID of the shape has been drawn. Nonlimiting examples are ZLineTo(ZPoint(100, 200)) or ZLineTo(100, 200).

The function ZAddLine( ) adds a point to the last line/polyline. The current position is neither used nor updated by ZAddLine. Parameters may be X, Y or ZPoint which specify the endpoint to be added to the line. The Return Value is the ID of the line/polyline that the point has been added to. Nonlimiting examples are ZAddLine(ZPoint(100, 200)) and ZAddLine(100, 200).

The function ZAddLineTo( ) adds a point to the last line/polyline. The current position is then set to the specified point. Parameters may be X, Y or ZPoint which specify the endpoint to be added to the line. The Return Value is the ID of the line/polyline that the point has been added to. Nonlimiting examples are ZAddLineTo(ZPoint(100, 200)) and ZAddLineTo(100, 200).

The function ZPolyLine( )draws a polyline. The current position is neither used nor updated by ZPolyLine. Parameters may be X1, Y1, X2, Y2, . . . , Xn, Yn or ZPoint or ZPoints which specfy the points of the polyline. The Return Value is the ID of the shape has been drawn. Nonlimiting examples are ZPolyLine(330, 450, 210, 0, 0, 0), ZPolyLine(ZPoint(330, 450), ZPoint(210, 0), ZPoint(0, 0)) and ZPolyLine(ZPoints(330, 450, 210, 0, 0, 0)).

The function ZAddPolyLine( ) adds a few points to the last line/polyline. The current position is neither used nor updated by ZAddPolyLine. Parameters may be X1, Y1, X2, Y2, . . . , Xn, Yn or ZPoint or ZPoints which specify the points to be added to the polyline. The Return Value is the ID of the line/polyline that the points have been added to. Nonlimiting examples are ZAddPolyLine(ZPoint(100, 200), ZPoint(400, 400), ZPoint(330, 210)), ZAddPolyLine(ZPoints(100, 200, 400, 400, 330, 210)) and ZAddPolyLine(100, 200, 400, 400, 330, 210).

The function ZPolygon( )draws a polygon. The current position is neither used nor updated by ZPolygon. Parameters may be X1, Y1, X2, Y2, . . . , Xn, Yn or ZPoint or ZPoints which specify the points of the polygon. The Return Value is the ID of the shape has been drawn. Nonlimiting examples are ZPolygon(330, 450, 210, 0, 0, 0), ZPolygon(ZPoint(330, 450), ZPoint(210, 0), ZPoint(0, 0)) and ZPolygon(ZPoints(330, 450, 210, 0, 0, 0)).

The function ZDelete( ) deletes the shapes specified by the shape IDs. Parameters may be Shape1ID, Shape2ID, . . . , ShapenID which specify the shape IDs to be deleted. Nonlimiting examples are var a=ZPolygon(330, 450, 210, 0, 0, 0), var b=ZLineTo(ZPoint(100, 200)) and ZDelete(a, b).

The function ZChange( ) resizes or moves the shape specified by the shape ID. It changes the coordinates of the box around the shape. Without being limiting one parameter is ShapeID which specifies the shape ID. Another parameter is LeftRect, TopRect, RightRect, BottomRect which specify the coordinates of the box outlining the shape. Nonlimiting examples are var a=ZPolygon(330, 450, 210, 0, 0, 0), ZChange(a,100, 200);//Move only, ZChange(a,100, 200, 400, 500);//Move and Resize, ZChange(a,0 , 0, 600, 800);//Resize only, ZChange(a,ZPoint(100, 200));//Move only.

The following is a sample script for Zpaint.

ZBeginPaint( );

ZSetCanvas(MyCanvas);

ZSetActiveFill(‘red’, ‘yellow’, 150);

ZEllipse(ZPoint(100, 100), ZPoint(200, 200));

ZSetActiveStroke(‘black’, 10);

ZSetActiveExtrusion(‘TRue’, “parallel”, ‘10dgfg’, “yellow”);

ZRectangle(ZPoints(400, 400, 200, 200));

var SavedGDC=ZSaveCurrentGDC( );

ZSetActiveFill(‘blue’);

ZSetActiveStroke(‘red’, ‘1px’, ‘sold’);

ZSetActiveExtrusion(‘TRue’, “parallel”, ‘20’);

ZArc(ZPoint(600, 600), ZPoint(200, 200), 30);

ZSetGDC(SavedGDC);

ZMoveTo(150,230);

var SomeShape=ZLineTo(ZPoint(150, 400));

ZAddPolyLine(ZPoints(300, 400,300,230));

ZAddLineTo(ZPoint(340,580));

ZAddPolyLine(223, 34, 34, 323, 564, 0);

ZMoveTo(100,100);

ZMoveTo(800,800);

ZImageTo(ZPoint(300,300, 500, 500), “Images/clockface2.jpg”);

ZChange(SomeShape, ZPoint(0,0), ZPoint(100,100));

ZDelete(SomeShape);

ZRoundRectangle(150, 230, 300, 400, 0.2);

ZRoundRectangle(150, 230, 300, 400, 0.0);

ZLine(330, 450, 210, 0);

ZImage(350, 460,600, 700, “Images/clockfacejpg”);

ZPolyLine(330, 450, 210, 0, 0, 0, 100);

var somey=10;

ZPolyLine(330, 450, 210, somey, 0, 0, 100);

One skilled in the art will appreciate readily that the present invention is well adapted to carry out the objects and obtain the ends and advantages inherent herein. The present examples, along with the methods, procedures, systems, and/or applications described herein are presently representative of preferred embodiments, are exemplary and are not intended as limitations on the scope of the invention. Changes therein and other uses will occur to those skilled in the art which are encompassed within the spirit of the invention as defined by the scope of the claims.

What is claimed is:

1. A recursive web browser system, comprising:
a computer having a processor and a recursive web browser configured to recursively display in a browser window thereof one or more recursive webpages having one or more ZCubes containing content therein;
a network connection to one or more other computers comprising a network;
a computer memory coupled to the processor storing at least one computer application including a plurality of functions effective to manipulate, singly or in combination, said ZCube(s) or the content therein or the recursive webpage(s) containing the same or a combination thereof within the recursive web browser, said computer memory further storing instructions adapted to be executed by the processor to enable operation of the functions thereon; and
means for retrieving or storing said ZCube(s) or content therein or a combination thereof from or onto said computer or the other computer(s) over the network.

2. The recursive web browser system of claim 2, further comprising means for storing said computer application onto a computer-readable storage medium.

3. The recursive web browser system of claim 2, further comprising means for launching a user-requested action to create one or more ZCubes.

4. The recursive web browser system of claim 3, wherein said means for launching a user-requested action is an action bar within a recursive browser window or an address bar located in a browser platform associated with the recursive web browser which triggers the action bar.

5. The recursive web browser system of claim 1, wherein one or more of the other computers includes a recursive web browser.

6. The recursive web browser system of claim 1, wherein the function(s) operate to organize one or more of the ZCubes within the recursive webpage(s).

7. The recursive web browser system of claim 6, wherein the function(s) operate to select a ZCube(s) or at least part of the content therein, to align ZCubes, to tile the ZCube(s), to array the ZCubes as a cascade, to layer the ZCubes, to delete a ZCube(s) or a part of the content therefrom or a combination thereof.

8. The recursive web browser system of claim 7, further comprising a function to group the selected ZCube(s) and to apply one or more other functions to the group.

9. The recursive web browser system of claim 8, wherein the other function(s) operate to resize the grouped ZCubes.

10. The recursive web browser system of claim 7, further comprising a function to display consecutively each ZCube comprising a selected set of ZCubes within another Zcube using timelines.

11. The recursive web browser system of claim 7, wherein the selecting function operates to rubberband ZCubes or at least part of the content therein into a selected set upon which other functions operate.

12. The recursive web browser system of claim 7, wherein the layering function operates to adjust layers of the ZCube(s) one on top of the other or to merge two or more layers thereby enabling viewing of all the contents contained therein.

13. The recursive web browser system of claim 12, further comprising function(s) operable to create a hierarchy of windows within one or more ZCubes.

14. The recursive web browser system of claim 6, wherein the function(s) operate to add one or more push pins or pointers to one or more ZCubes.

15. The recursive web browser system of claim 1, wherein the functions operate to arithmetically manipulate the content of the ZCube(s).

16. The recursive web browser system of claim 15, wherein the functions operate to add content from a ZCube(s) to another ZCube, to subtract content of two or more ZCubes from a first ZCube, to multiply the content of a ZCube a user-selected number of times, or to divide content of a ZCube into one or more new ZCubes.

17. The recursive web browser system of claim 1, wherein the function(s) operate to manipulate HTML code or objects comprising the ZCube(s) or content therein or the recursive webpages containing the same.

18. The recursive web browser system of claim 17, wherein the functions operate to enable drag and drop functionalities.

19. The recursive web browser system of claim 18, wherein the functions operate to drag and drop color, formats, font-size, font-type, font-color, font-weight, transitions, or filters into an HTML webpage or a combination thereof.

20. The recursive web browser system of claim 17, wherein the functions operate to extract one or more links from a ZCube(s).

21. The recursive web browser system of claim 20, wherein the functions operate to explode link(s), extract media, explore the link(s) using an associated URL tree or execute the link(s) as a script or a combination thereof.

22. The recursive web browser system of claim 1, wherein the functions operate to enable graphical and scripting functionalities in a recursive webpage.

23. The recursive web browser system of claim 22, wherein the functions operate to create handdrawn or handwritten content in the recursive webpage using VML or SVG.

24. The recursive web browser system of claim 23, further comprising functions operable on the hand-drawn or handwritten content to apply selected color(s), to fill, to shadow, to make 3-dimensional, to rotate in x-y-z directions, to add text or handwriting, to animate using timelines, or a combination thereof.

25. The recursive web browser system of claim 24, further comprising functions operable to memorize a scheme of selected colors or drawing functions and retrievably store the same.

26. The recursive web browser system of claim 1, wherein the functions operate to save the recursive webpage, including the ZCube(s), as read and write files, read-only files or secured files.

27. The recursive web browser system of claim 1, wherein the ZCube(s) content comprises one or both of a graphical object or a photographic object.

28. The recursive web browser system of claim 27, wherein the functions operate on the ZCube(s) content to drag and drop one or more of color(s), format(s), text(s), transition(s), or special effect(s) thereon or to size, position, rotate in x-y-z directions, zoom or unzoom, layer, script, animate using a timeline, or make 3-dimensional, or a combination thereof.

29. The recursive web browser system of claim 28, wherein the ZCube(s) content is a photographic object, further comprising functions operable to create hand-drawn content thereon, to create handwritten content thereon, to add push pin(s) thereto, or a combination thereof.

30. A recursive web browser, comprising:
a recursive browser window configured to recursively display one or more recursive webpages having one or more ZCubes containing content therein;
means for accessing a computer memory coupled to a processor and storing the at least one computer application including the plurality of functions of claim 1, said computer memory further storing instructions adapted to be executed by the processor to enable operation of the functions on the ZCube(s) or the content therein or the recursive webpage(s) containing the same or a combination thereof;
means for launching a user-requested address or action; and
means for storing the computer application onto a computer-readable storage medium.

31. The recursive web browser of claim 30, further comprising:
a network connection to one or more computers comprising a network; and
means for retrieving or storing the ZCube(s) or content thereof from or onto the other computer(s) over the network.

32. The recursive web browser of claim 30, wherein said means for launching a user-requested action is an action bar within a recursive browser window or an address bar located in a browser platform associated with the recursive web browser which triggers the action bar.

33. A computer-readable storage medium that tangibly stores a computer application including a plurality of functions effective to manipulate, singly or in combination, one or more ZCubes or content therein or one or more recursive webpages containing the same or a combination thereof displayed in recursive browser window comprising a recursive web browser system, said computer-readable storage medium further storing instructions adapted to be executed by a processor to enable operation of the functions thereon.

34. The computer-readable storage medium of claim 33, wherein the function(s) operate to organize one or more of the ZCubes within the recursive webpage(s).

35. The computer-readable storage medium of claim 34, wherein the function(s) operate to select a ZCube(s) therewithin, to align ZCubes, to tile the ZCube(s), to array the ZCubes as a cascade, to layer the ZCubes, to delete a ZCube(s) or a part of the content therefrom or a combination thereof.

36. The computer-readable storage medium of claim 35, further comprising a function to group the selected ZCube(s) and to apply one or more other functions to the group.

37. The computer-readable storage medium of claim 36, wherein the other function(s) operate to resize the grouped ZCubes.

38. The computer-readable storage medium of claim 35, further comprising a function to display consecutively each ZCube comprising a set of ZCubes within another Zcube using timelines.

39. The computer-readable storage medium of claim 35, wherein the selecting function operates to rubberband ZCubes or at least part of the content therein into a selected set upon which other functions operate.

40. The computer-readable storage medium of claim 35, wherein the layering function operates to adjust layers of the ZCube(s) one on top of the other or to merge two or more layers thereby enabling viewing of all the contents contained therein.

41. The computer-readable storage medium of claim 40, further comprising creating a hierarchy of windows within one or more ZCubes.

42. The computer-readable storage medium of claim 34, wherein the function(s) operate to add one or more push pins or pointers to one or more ZCubes.

43. The computer-readable storage medium of claim 33, wherein the functions operate to arithmetically manipulate the content of the ZCube(s).

44. The computer-readable storage medium of claim 43, wherein the functions operate to add content from a ZCube(s) to another ZCube, to subtract content of two or more ZCubes from a first ZCube, to multiply the content of a ZCube a user-selected number of times, or to divide content of a ZCube into one or more new ZCubes.

45. The computer-readable storage medium of claim 33, wherein the function(s) operate to manipulate HTML code or objects comprising the ZCube(s) or content therein or the recursive webpages containing the same.

46. The computer-readable storage medium of claim 45, wherein the functions operate to enable drag and drop functionalities.

47. The computer-readable storage medium of claim 46, wherein the functions operate to drag and drop color, formats, font-size, font-type, font-color, font-weight, transitions, or filters into an HTML webpage or a combination thereof.

48. The computer-readable storage medium of claim 45, wherein the functions operate to extract one or more links from a ZCube(s).

49. The computer-readable storage medium of claim 48, wherein the functions operate to explode link(s), extract media, explore the link(s) using an associated URL tree or execute the link(s) as a script or a combination thereof

50. The computer-readable storage medium of claim 33, wherein the functions operate to enable graphical and scripting functionalities in the recursive webpage.

51. The computer-readable storage medium of claim 50, wherein the functions operate to create handdrawn or handwritten content in the recursive webpage using VML or SVG.

52. The computer-readable storage medium of claim 51, further comprising functions operable on the hand-drawn or handwritten content to apply selected color(s), to fill, to shadow, to make 3-dimensional, to rotate in x-y-z directions, to add text or handwriting, to animate using timelines, or a combination thereof.

53. The computer-readable storage medium of claim 52, further comprising functions operable to memorize a scheme of selected colors or drawing functions and retrievably store the same.

54. The computer-readable storage medium of claim 33, wherein the functions operate to save the recursive webpage, including the ZCube(s), as read and write files, read-only files or secured files.

55. The computer-readable storage medium of claim 33, wherein the ZCube(s) content comprises one or both of a graphical object or a photographic object.

56. The computer-readable storage medium of claim 55, wherein the functions operate on the ZCube(s) content to drag and drop one or more of color(s), format(s), text(s), transition(s), or special effect(s) thereon or to size, position, rotate in x-y-z directions, zoom or unzoom, layer, script, animate using a timeline, or make 3-dimensional, or a combination thereof.

57. The computer-readable storage medium of claim 56, wherein the ZCube(s) content is a photographic object, further comprising functions operable to create hand-drawn content thereon, to create handwritten content thereon, to add push pin(s) thereto, or a combination thereof.

58. A computer-implemented method for altering one or more ZCubes or content therein or a recursive webpage comprising the same displayed within a recursive web browser environment, comprising:
displaying recursively one or more ZCubes or one or more recursive webpages comprising the same within a recursive browser window of one or more computers comprising the recursive web browser system of claim 1; and
executing the computer application therein, said computer application enabling the plurality of functions of claim 1, said functions operable to manipulate, singly or in combination, the HTML code or objects comprising the one or more ZCubes or content therein or recursive webpage comprising the same or a combination thereof thereby altering the ZCubes or content therein or the recursive webpage.

59. The computer-implemented method of claim 58, further comprising:
retrieving or storing the ZCube(s) or content therein from or onto the computers over the network.

60. The computer-implemented method of claim 58, further comprising:
storing the computer application onto a computer-readable storage medium.

61. The computer-implemented method of claim 58, further comprising:
launching a user-requested action to create the one or more ZCubes.

62. The computer-implemented method of claim 61, wherein said user-requested action is launched from an action bar within the recursive browser window or an address bar located in a browser platform associated with the recursive web browser which triggers the action bar.
